(19) United States
(12) Patent Application Publication
(10) Pub. No.: US 2015/0081166 A1
(43) Pub. Date: Mar. 19, 2015

(54) WEAR MONITORING SYSTEM FOR A TRACK ROLLER

(71) Applicant: Caterpillar Inc., Peoria, IL (US)

(72) Inventors: Mark S. Diekevers, Germantown Hills, IL (US); Roger L. Recker, Dunlap, IL (US)

(73) Assignee: Caterpillar Inc., Peoria, IL (US)

(21) Appl. No.: 14/549,570

(22) Filed: Nov. 21, 2014

(51) Int. Cl. B62D 55/14; G01N 3/56

(52) U.S. Cl. CPC B62D 55/14; G01N 3/56
USPC 701/34.4

(57) ABSTRACT

A wear monitoring system for monitoring wear of a surface of a track roller associated with an undercarriage of a machine. The wear monitoring system includes a sensing device positioned beneath a top surface of the track roller. The sensing device includes a probe configured to undergo wear along with the top surface of the track roller, a controller circuit configured to monitor an extent of wear of the top surface of the track roller based on the wear of the probe, an antenna, and a power source. The wear monitoring system further includes a transceiver configured to transmit a signal indicative of the extent of wear of the track roller. The wear monitoring system further includes a monitoring device configured to generate an output indicative of the extent of wear of the track roller.

### TECHNICAL FIELD

The present disclosure relates to a wear monitoring system of an undercarriage component, and more particularly to a wear monitoring system for a track roller.

### BACKGROUND

A mobile machine may be used to perform various types of work on different worksites, such as, a construction site, a demolition site, a mining site, or a landfill site. For example, a bulldozer may be used to push soil and rock on a construction site. Operation of the mobile machine may result in wear or damage to various components, including components of an undercarriage assembly of the mobile machine, such as, track links and roller assemblies. For example, as a track assembly operates, a surface of each track link may wear away through contact with other components of the track assembly, machine, and/or outside materials (e.g., the ground).

It is known to service or replace a machine component, for example, when the component exceeds its expected lifetime (based on the age of the component or number of hours of use experienced by the component), or based on the results of inspection or evaluation of the component. The evaluation of whether the component has undergone sufficient wear for replacement thereof may be determined based on manual inspection of the component. Alternatively, a diagnostic system associated with the component may be used to determine if the component has undergone wear.

U.S. Pat. No. 6,360,850 describes a progressive brake lining wear and temperature sensor having a plurality of parallel arranged spaced apart resistors in connection with a sensing circuit. Each resistor is mounted onto a PC board which in turn is encapsulated within a single molding. A thermistor is also mounted onto the PC board within the molding to sense lining temperature. The thermistor is connected to a ground lead. The ground lead, resistance lead and thermistor lead emerge from the encapsulated sensor for connection to the sensing circuit. The sensor is disposed within the brake lining and is connected to the brake shoe by a securement clip. As the brake lining progressively wears, the resistors are progressively worn away thus changing the overall resistance of the sensor. The change in resistance indicates state of wear.

### SUMMARY OF THE DISCLOSURE

In one aspect of the present disclosure, a wear monitoring system for monitoring wear of track roller is provided. The wear monitoring system for the track roller includes a sensing device positioned beneath a top surface of the track roller. The sensing device includes a probe configured to undergo wear along with the top surface of the track roller, a controller circuit configured to monitor an extent of wear of the top surface of the track roller based on the wear of the probe, an antenna configured to transmit a signal indicative of the extent of wear of the track roller, and a power source configured to provide power to the controller circuit. The wear monitoring system further includes a transceiver configured to receive the signal from the antenna and transmit a signal indicative of the extent of wear of the track roller. The wear monitoring system further includes a monitoring device configured to generate an output indicative of the extent of wear of the track roller.

Other features and aspects of this disclosure will be apparent from the following description and the accompanying drawings.

### BRIEF DESCRIPTION OF THE DRAWINGS

FIG. 1 is a side view of an exemplary machine having an undercarriage, according to one embodiment of the present disclosure;

FIG. 2 is a block diagram of a wear monitoring system, according to one embodiment of the present disclosure;

FIG. 3 is a cross-sectional front view of a track roller of the undercarriage provided with a sensing device, according to one embodiment of the present disclosure;

FIG. 4 is a cross sectional perspective view of an idler of the undercarriage provided with the sensing device, according to other embodiments of the present disclosure;

FIG. 5 is a is a cross-sectional side view of a track shoe of the undercarriage provided with the sensing device, according to other embodiments of the present disclosure; and

FIG. 6 is a cross-sectional front view of a drive sprocket of the undercarriage provided with the sensing device, according to other embodiments of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

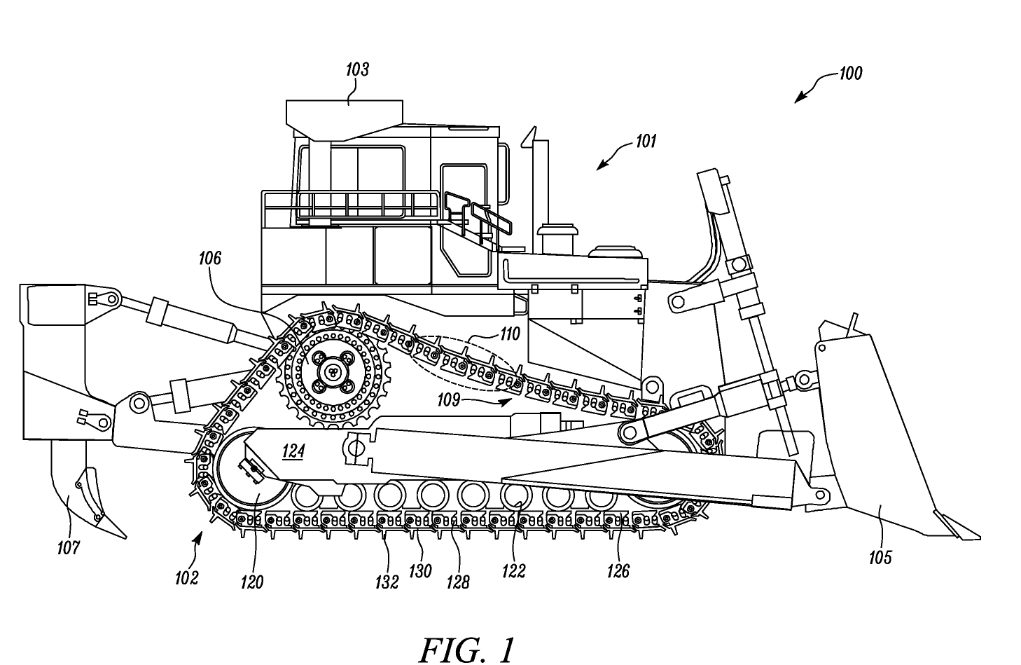

FIG. 1 illustrates an exemplary machine 100. In the illustrated embodiment, the machine 100 is a track-type tractor. However, present disclosure may be embodied in any type of machine having an undercarriage assembly, for example, skid steers, dozers, excavators, backhoes, track loaders, and the like. The machine 100 includes an upper body 101 supported by an undercarriage 102. The upper body 101 may include an operator cabin 103. Further, a power source (not shown), such as an engine, may be disposed in the upper body 101. The power source may be configured to generate power to propel the machine 100, and operate a first implement 105 and a second implement 107 of the machine 100. Further, the first and second implements 105, 107 are a blade assembly and a ripper, respectively. However, the concepts of the present disclosure may be embodied in any type of machine having an undercarriage assembly 102, for example, skid steers, dozers, excavators, backhoes, track loaders, and the like.

The undercarriage 102 may include a pair of track assemblies 109 (only one shown) on opposing sides of the machine 100. The track assembly 109 may include a track 110, a drive sprocket 106, at least one idler 120, a plurality of track rollers 122, and a frame assembly 124. The track 110 may form a continuous structure operatively coupled to the drive sprocket 106, the idlers 120, and the track rollers 122. Further, the power source of the machine 100 may transmit power to the drive sprocket 106 via a driving mechanism. The driving mechanism may include a mechanical drive, a hydraulic drive, an electric drive, or a combination thereof.

The frame assembly 124 may carry the idlers 120. The frame assembly 124 may include multiple members (not shown) movable longitudinally relative to one another. During operation, a relative movement between the members of the frame assembly 124 may move the idlers 120 relative to one another. Further, rotation of the drive sprocket 106 may cause the drive the track 110 to move around the drive sprocket 106, the idlers 120, and the track rollers 122 to engage a ground surface, and thereby propel the machine 100. The drive sprocket 106 may be driven in different directions to propel the machine 100 in forward or reverse directions. Further, the machine 100 may be steered by providing differential power to the drive sprockets 106 of the corresponding track assemblies 109.

In an exemplary embodiment, the track 110 may include a plurality of interconnected track links 126. Adjacent track links 126 may be rotatably coupled together via a track pin assembly 128. The track pin assembly 128 may be engaged by teeth of the drive sprocket 106 to drive the track 110 around the drive sprocket 106, the idlers 120, and the track rollers 122.

The track 110 may further include a plurality of track shoes 130 secured to the track links 126. Each track shoe 130 may include a connecting portion configured to be secured to one or more of the track links 126 and a ground engaging portion 132 configured to contact the ground. The ground engaging portion 132 may include one or more portions (e.g., grouser bars) that provide increased traction between the track shoes 130 and the ground. It should be understood that the various components of the undercarriage 102, described above, are purely exemplary and not intended to be limiting of the present disclosure.

During operation, one or more undercarriage components, such as, for example, the track rollers 122, the track shoes 130, the track links 126, and the track pin assemblies 128, may undergo wear. These undercarriage components may require replacement and/or repair based on an extent of wear. The present disclosure relates to a wear monitoring system 200 configured to monitor an extent of wear of one or more undercarriage components, as will be explained hereinafter in detail.

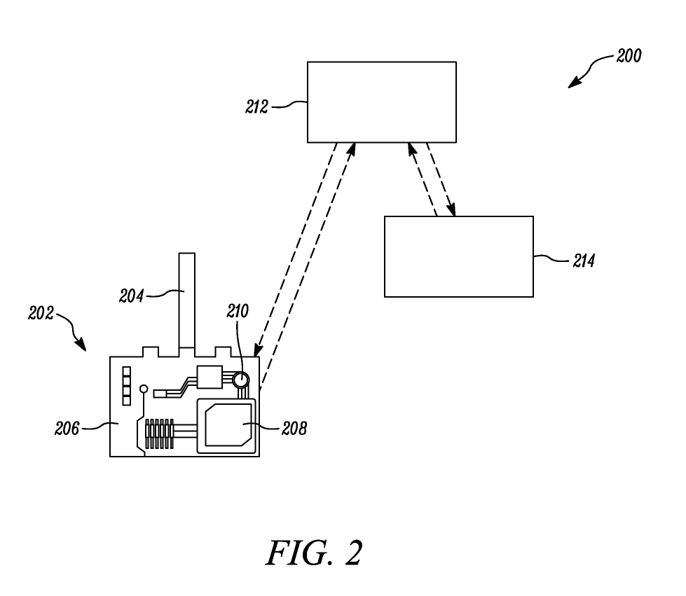

FIG. 2 illustrates the wear monitoring system 200 configured to monitor wear of the undercarriage component, according to some embodiments of the present disclosure. In the illustrated embodiment of FIG. 2, various components of the wear monitoring system 200 are described. The wear monitoring system 200 includes a sensing device 202. The sensing device 202 may include one or more tangible, non-transitory hardware components, including one or more central processing units (CPUs) or processors. For example, the sensing device 202 may include a probe 204 configured to directly and/or indirectly measure, sense, and/or otherwise receive information pertaining to wear of an undercarriage component as input. The probe 204 may be a portion of the sensing device 202 that is configured to wear away with wearing of the undercarriage component. For example, the probe 204 may be a resistance member (e.g., one or more resistors) configured such that, as the probe 204 wears away, a resistance value associated with the resistance member changes. This change in resistance may be correlated with an amount of material that has worn away from the undercarriage component. In other embodiments, the probe 204 may take another configuration (e.g., other than being a resistance member, an alternative shape, etc.). Further, in some embodiments, the probe 204 may not be a wear portion, and may be another device configured to detect a wear characteristic (e.g., a depth sensor).

The sensing device 202 may further include a controller circuit 206 configured to generate, receive, transmit, and/or modify a signal indicative of an extent of wear detected by the sensing device 202. For example, the controller circuit 206 may include a signal conditioner, an amplifier, a multiplexer, and/or a converter (e.g., an analog-to-digital (A/D) converter or a digital-to-analog (D/A) converter). In an embodiment, the controller circuit 206 may be configured to detect a change in the resistance value of the probe 204 due to wear. The controller circuit 206 may be further configured to determine an extent of wear of the surface of the undercarriage component based on the change in the resistance value of the probe 204. It should be understood that these components are exemplary and that additional and/or alternative circuitry components may be used, depending on the configuration of the probe 204.

The sensing device 202 may further include an antenna 208 configured to transmit a signal indicative of the extent of wear of the surface of the undercarriage component. The antenna 208 may be a radio device configured to wirelessly broadcast an output provided by the controller circuit 206. Alternatively or additionally, an output port (not shown), such as, for example a USB (universal serial bus) port or similar port, may transmit the output provided by the controller circuit 206 through a cable or other connection removably connected to the output port.

The sensing device 202 may further include a power source 210 (not shown) configured to provide power to the controller circuit 206. In an embodiment, the power source 210 may include a battery, such as, a coin-cell type battery. In some embodiments, the power source 210 may additionally or alternatively include a motion-based energy source, such as, a vibration-based energy-harvesting system, to power one or more of the components of the sensing device 202, and/or may be used to charge a battery of the power source 210. In yet another embodiment, the power source 210 may include a battery capable of being wirelessly charged (e.g., near-field charging). In this way, the sensing device 202 may be embedded within the undercarriage component while being capable of receiving electrical power from outside, and thus reducing on-board power (e.g., battery) requirements.

The wear monitoring system 200 further includes a transceiver 212 in communication with the sensing device 202. The transceiver 212 may be located remote to the sensing device 202. In an embodiment, the transceiver 212 may be a radio-frequency (RF) type device and may wirelessly communicate with the sensing device 202 by various methods known in the art, for example, Bluetooth, Near field communication (NFC), infrared, radio waves, cellular networks like GSM, CDMA, WCDMA, HSPA, HSUPA, HSDPA, or any other known wireless communication methods. The transceiver 212 may be configured to receive a signal indicative of the extent of wear of the undercarriage component from the antenna 208.

The transceiver 212 may be further configured to transmit a signal indicative of the extent of wear of the surface of the undercarriage component to a monitoring device 214. The monitoring device 214 may be a computing device, such as an on-board or an off-board controller. The on-board controller may be a computing device located on the machine 100 (e.g., inside the operator cabin 103). For example, the on-board controller may be an electronic control module including at least a processor and a display. The off-board controller may be a similar computing device located away from the machine 100 at a remote location. The off-board controller may also include at least a processor and a display.

In an embodiment, the monitoring device 214 may be configured process the signal indicative of the extent of wear, and further generate an output indicative of the extent of wear of the undercarriage component. For example, the on-board or off-board controller may be configured to communicate with the transceiver 212 (e.g., via a wireless network) to receive wear information, which may be displayed to an operator within the operator cabin 103 or at the remote location from the machine 100. In an example, the output generated by the monitoring device 214 may be an audio, visual, tactile or a combination thereof type feedback.

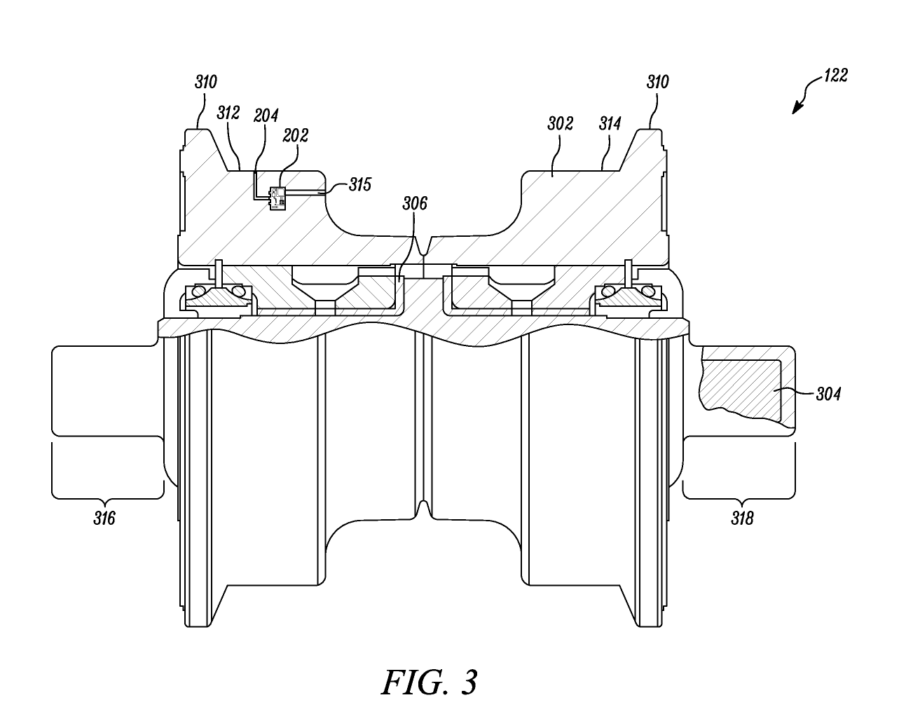

FIG. 3 illustrates a cross sectional view of the track roller 122, wear monitoring of the track roller 122 through the wear monitoring system 200 according to an embodiment of the present invention is described. The track roller 122 includes a roller body 302, a pin 304, and a bushing 306. The roller body 302 facilitates movement of the track 110 around the undercarriage 102. The roller body 302 is an example of a roller with a solid roller body in which the roller body 302 is one piece. The roller body 302 includes a plurality of flanges 310. The track 110 makes contact with the roller body 302 at top surfaces 312 and 314 adjacent to the flanges 310. The roller body 302 includes end 316 and end 318 opposite to end 316. The ends 316 and 318 of the roller body 302 are each configured to fit in respective housings (not shown) within the track assembly 109. With continuous movement of the track 110 relative to the flange 310 as the machine 100 operates, rubbing and frictional forces may tend to wear the top surfaces 312 and 314.

In an embodiment, the wear monitoring system 200 is employed to monitor wear of the surfaces 312 and 314 of the roller body 302. The sensing device 202 is embedded into or positioned beneath any one or both of the top surfaces 312 and 314 of the track roller 122. In one embodiment, the sensing device 202 is positioned approximately between 2-200 mm from the top surface 312 adjacent to a cavity 315. The cavity 315 allows the sensing device 202 to communicate in an open environment via the antenna 208. In other embodiments, the sensing device 202 may be positioned approximately between 10-50 mm, 50-150 mm, or 100-200 mm from the top surface 312. For example, as shown in FIG. 3, the sensing device 202 may be positioned in such a manner that the probe 204 of the sensing device 202 may be in close proximity or in contact with the top surface 312. In one embodiment, the probe 204 of the sensing device 202 may be in close proximity or in contact with the top surface 314. As explained earlier, the probe 204 is a portion of the sensing device 202 configured to wear away with wearing of the top surface 312. The wearing of the probe 204 is indicative of wearing of the top surface 312. A person of ordinary skill in the art will appreciate that the sensing device 202 may be held in position beneath the top surface 312 of the track roller 122 using any known method. For example, the sensing device 202 may be placed within a cavity present beneath the top surface 312.

Further, as a threshold wear limit of the top surface 312 of the track roller 122 is reached, the sensing device 202 transmits a signal indicative of the extent of wear of the top surface 312 to the transceiver 212. The transceiver 212 is further configured to transmit the signal indicative of the extent of wear to the monitoring device 214. As described earlier, the monitoring device 214 processes the signal indicative of the extent of wear of the surface 312 and further generates an output indicative of the extent of wear of the surface 312 over an on-board or off-board controller.

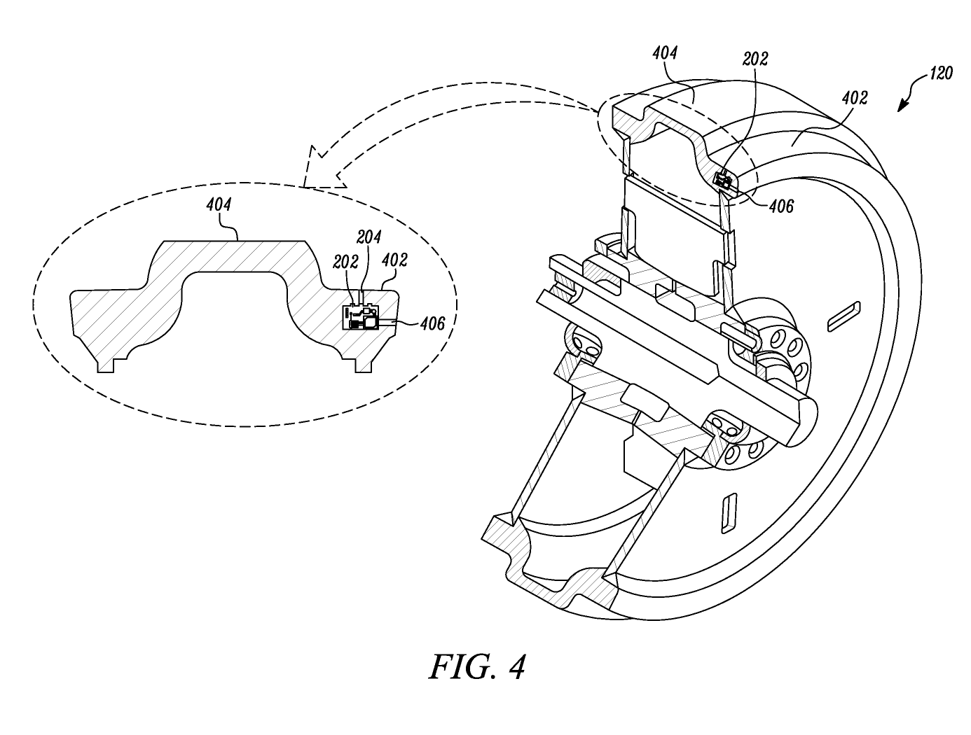

FIG. 4 illustrates the sensing device 202, embedded within another undercarriage component, according to other embodiments of the present disclosure. The sensing device 202 is positioned within the idler 120. In the illustrated embodiment, the sensing device 202 may be configured to detect wear of a surface 402 of a tread shoulder of the idler 120. Accordingly, the probe 204 of the sensing device 202 is configured to contact with the surface 404 of the idler 120. The sensing device 202 may be positioned approximately between 2-200 mm below the surface 402 adjacent to a cavity 406 of the idler 120. The cavity 406 allows the sensing device 202 to communicate in an open environment via the antenna 208. In other embodiments, the sensing device 202 may be positioned approximately between 10-50 mm, 50-150 mm, or 100-200 mm below the surface 404 of the idler 120. Alternatively, the sensing device 202 may be disposed below surface 404 of the idler 120. A person of ordinary skill in the art will appreciate that the sensing device 202 may be held in position using any known method.

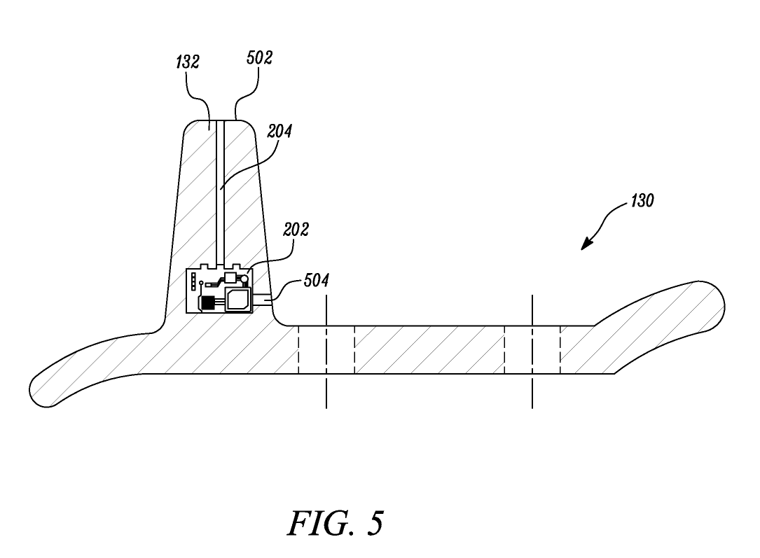

FIG. 5 illustrates the sensing device 202 embedded in the track shoe 130 of the undercarriage, according to an embodiment of the present disclosure. In the illustrated embodiment, the sensing device 202 may be configured to detect wear of a surface 502 of the track shoe 130. The track shoe 130 may include the ground engaging portion 132 that contacts the ground during travel of the machine 100. The ground engaging portion 132 may be the grouser bar associated of the track shoe 130. The sensing device 202 may be positioned approximately between 2-200 mm below the surface 502 adjacent to a cavity 504 of the track shoe 130. The cavity 504 allows the sensing device 202 to communicate in an open environment via the antenna 208. In other embodiments, the sensing device 202 may be positioned approximately between 10-50 mm, 50-150 mm, or 100-200 mm below the surface 502 of the track shoe 130. The sensing device 202 may be disposed proximate the surface 502 of the ground engaging portion 132 such that the probe of the sensing device is in contact with the surface 502 of the track shoe 130. A person of ordinary skill in the art will appreciate that the sensing device 202 may be held in position using any known method.

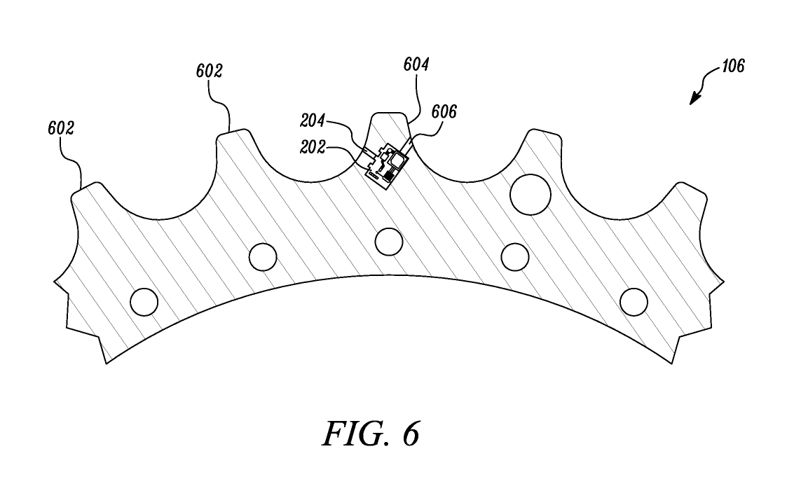

FIG. 6 illustrates the sensing device 202 embedded on the drive sprocket 106. In the illustrated embodiment, the sensing device 202 may be configured to detect wear of a sprocket tooth 602. The drive sprocket 106 is configured to drive the track 110, i.e. as the drive sprocket 106 rotates; the sprocket tooth 602 maintains variable pushing contact with the track 110. This may make the sprocket tooth 602 exposed to multitude of variable cyclic loads that may lead to wear thereof. In the illustrated embodiment, the sensing device 202 may be configured to detect wear of a surface 604 of the sprocket tooth 602, such that the probe 204 of the sensing device 202 is in contact with the surface 604. The sensing device 202 may be positioned approximately between 2-200 mm below the surface 604 adjacent to a cavity 606 of the sprocket tooth 602. The cavity 606 allows the sensing device 202 to communicate in an open environment via the antenna 208. In other embodiments, the sensing device 202 may be positioned approximately between 10-50 mm, 50-150 mm, or 100-200 mm below the surface 604 of the sprocket tooth 602. The sensing device 202 may be disposed proximate the surface 604 of the sprocket tooth 602. A person of ordinary skill in the art will appreciate that the sensing device 202 may be held in position using any known method.

It may be contemplated that the wear monitoring system 200 may include multiple sensing devices 202 disposed on the corresponding undercarriage components. In an embodiment, the multiple sensing devices 202 may be in communication with a single transceiver 212. Alternatively, a separate transceiver 212 may be provided for each sensing device 202. Further, the orientation and dimensions of the sensing device are not limited to that described herein.

### INDUSTRIAL APPLICABILITY

The present disclosure is related to the wear monitoring system 200 for the undercarriage 102 of the machine 100. The monitoring system 200 may include the sensing device 202 for detecting wear of the undercarriage component. Further, the sensing device 202 may be in communication with a transceiver 212, the transceiver 212 may further be in communication with a monitoring device 214. The monitoring device 214 may be configured to generate an output indicative of wear of the undercarriage component. As explained above, the undercarriage component may include, for example, but not limited to, the track link 126, the idler 120, the track roller 122, and the track shoe 130.

The wear monitoring system 200 may enable real time monitoring of wear of the undercarriage component. Further, the sensing device 202 may be an ultrasonic sensor disposed on the undercarriage component, thereby enabling accurate determination of an extent of wear. Extent of wear may indicate whether the undercarriage component requires repair and/or replacement. Further, the wear monitoring system 200 may provide an alert if the undercarriage component requires immediate attention, thereby preventing any possible failures of the undercarriage component. Hence, machine downtimes may be reduced.

The wear monitoring system 200 may also be configured to store wear data. The wear data may be accessible in order to optimize maintenance and operation schedules of the machine 100, determine working life of various undercarriage components etc. Further, manual inspection of the undercarriage components may be reduced.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A wear monitoring system for monitoring wear of a surface of a track roller associated with an undercarriage of a machine, the wear monitoring system comprising:
a sensing device positioned beneath a top surface of the track roller, the sensing device including:
a probe extending to the top surface of the track roller, wherein the probe is configured to undergo wear along with the top surface of the track roller;
a controller circuit in communication with the probe, the controller circuit configured to detect a change in an electrical resistance of the probe due to wear, the controller circuit further configured to determine an extent of wear of the top surface of the track roller based on the change in the electrical resistance of the probe;
an antenna in communication with the controller circuit, the antenna configured to transmit a signal indicative of the extent of wear of the top surface of the track roller; and
a power source configured to provide power to the controller circuit;
a transceiver located remote to the sensing device, the transceiver configured to receive the signal from the antenna and transmit a signal indicative of the extent of wear of the top surface of the track roller; and
a monitoring device in communication with the transceiver, wherein the monitoring device is configured to generate an output indicative of the extent of wear of the track roller.
